(19) United States
(12) Patent Application Publication
(10) Pub. No.: US 2019/0171982 A1
(43) Pub. Date: Jun. 6, 2019

(54) Financial Modeling and Prediction System

(71) Applicant: Robert J. Kirk, Murphy, TX (US)

(72) Inventor: Robert J. Kirk, Murphy, TX (US)

(21) Appl. No.: 15/830,027

(22) Filed: Dec. 4, 2017

(51) Int. Cl. G06Q 10/06

(52) U.S. Cl. CPC G06Q 10/067; G06Q 40/12

(57) ABSTRACT

A financial analysis system retrieves data from a myriad of public and/or private data sources to develop a financial model that takes into account many life situations that an individual may experience. Together with detailed information regarding the individual such as age, race/ethnic background, marital status, occupation, family information, health data, career data, place of living/work, expected future expenditures, goals, lifestyles, etc. From these, the financial analysis system predicts future financial situations such as savings/assets, cash flow, etc., based upon the individual's data in view of the myriad of data sources that are available, providing a more accurate view of what the future financial situation shall be for that individual.

### FIELD

This invention relates to the field of finances and more particularly to a system for modeling and predicting future financial status.

### BACKGROUND

Many individuals are concerned about their future. Besides health and other family concerns most are concerned about finances. “Will I have enough money to pay for a house, a car, raising a family, my children's education, healthcare, eldercare, and the biggest question, retirement?”

Today, there are many tools for individuals or for financial advisors that attempt to provide insights into the individual's financial future. Some use a “goals-based” system, while some use a cash-flow based system in their approach. In these tools, the individual's age, income, and assets are used in calculations that make broad assumptions to arrive at yearly financial status or, at financial status at a particular point in time such as at retirement. Some use actuary tables to make assumptions as to how long an individual is expected to live. No present planning and/or prediction system utilizes future cash flow requirements based upon life events and the expected age of the individual at which these live events are likely to occur, thereby generating financial impact when they occur. Likewise, none of the tools incorporate the uniqueness of each individual into the planning, such as health, backgrounds, education, ethnicity, etc.

These financial planning tools provide very vague and often inaccurate financial status, as everybody who uses these tools is different. Consider two individuals, both age 30, one male and Hispanic and one female who is Caucasian. The male is an engineer and the female is a construction worker. Both earn substantially the same salary and bonus of $35,000.00 per year. Both have minimal assets but want to own a home by the time they are 40. Using the existing financial analysis tools, the financial outlook for both individuals will be virtually the same because existing financial analysis tools do not take into consideration likely events that will occur in the future, for example, over the next ten years. There are many considerations that existing financial analysis tools do not consider. For example, does either individual have a higher risk of a certain illness that will impact earning potential? Does either individual have an earning cap or a lower potential for pay increases (e.g. glass ceiling)? Will either individual experience a birth of one or more children, a divorce, an inheritance, an elderly parent living with them? Where do each live? What is the future expected demand for each individual's work/career in the location that the individual lives, and hence expected future earnings?

There are many more parameters that will, in general, have effect on an individual's future financial status. Most or all of these parameters are not considered as existing financial analysis tools typically capture individual data such as age, marital status, asset information, loan amounts and payments, list of known future expenditures (e.g. plans to attend college, schooling for dependents, weddings, vacations), and some data regarding yearly expenses. From this minimal data, calculations are made as to life expectancy and future assets based upon earnings, expected investment returns, interest rates, taxes, and current assets. There is no account taken into any of the parameter's listed above, though it is known that people in one occupation have greater earnings potential than in another, people who live in cities have greater expenses than those outside of cities, (unfortunately) males have greater earnings potential than females in today's US society, certain individuals are likely to have more children than others, certain individuals are more likely to experience certain illnesses and associated expenses, individuals are often likely to marry, divorce, remarry, etc., each having associated financial impacts.

As an example of the limitations of existing financial planning systems, using the user's name, birthdate, age, sex of the user, current assets and asset types, housing data (e.g. home value, mortgage), these tools utilize, for example, actuary tables to predict the end of life of the user, possibly to determine cash flow during retirement. The predictions have little accuracy, as without also understanding certain health-related issues of the user, the end of life will be very inaccurate. For example, many things effect life expectancy including the user's genetic background (e.g. a parent with high blood pressure), the user's lifestyle (e.g. exercise levels, overweight, underweight, diet), user's medical status (e.g. diabetes, high blood pressure), etc. Knowing more about the health of the user enables greater accuracy in predicting the end of life (as well as other life events). The prior art does not utilize such information to make life event predictions such as end of life.

Predictions of financial futures require much more information to be reasonably accurate and to provide a more realistic summary of what will be given the current situation and course of the individual.

None of the existing systems incorporate future cash flow requirements of upcoming life events, the expected age for when they occur, the financial impact, or the uniqueness specifically associated to each of us as individuals.

What is needed is a system that will utilize personal data and demographic data to generate future financial models that more accurately depict what will be for an individual.

### SUMMARY

A financial analysis system retrieves data from a myriad of public and/or private data sources to develop a financial model that takes into account many life situations that an individual may experience. Together with detailed information regarding the individual such as age, race/ethnic background, marital status, occupation, family information, health data, career data, place of living/work, expected future expenditures, goals, lifestyles, etc. From these, the financial analysis system predicts future financial situations such as savings/assets, cash flow, etc., based upon the individual's data in view of the myriad of data sources that are available, providing a more accurate view of what the future financial situation shall be for that individual.

In one embodiment, a system for financial prediction is disclosed including a computer and a plurality of data sources that are accessible by the computer (e.g. government or private data sources). For each data source, software running on the computer accesses the each data source, extracts data from the each data source, and inputs the data into a knowledge base having artificial intelligence. The software the gathers user data including a name of a user, an age of the user, a gender of the user, an ethnicity of the user, and a current financial profile related to the user of the system for financial prediction. Next, using the user data and the knowledge base, the software predicts future life events, the life events associated with financial impact to a financial profile of the user and using the future life events and the financial impact, the software generates a report showing the life events and financial data over time.

In another embodiment, a method of making financial predictions is disclosed including identifying a plurality of data sources. For each data source of the plurality of data sources, each data source is accessed, data is extracted from the each data source, and the data is imported into a knowledge base. The knowledge base has artificial intelligence. Next, user data is gathered from a user. The user data includes a name of a user, an age of the user, a gender of the user, an ethnicity of the user, and a current financial profile related to the user. Next, the user data and the knowledge base is used to predict future life events, the life events associated with financial impact to a financial profile of the user. Using the future life events and the financial impact, a report showing the life events and financial data over time is generated.

In another embodiment, a system for financial prediction is disclosed including a computer and a plurality of data sources that are accessible by the computer. The plurality of data sources includes, at least, a bureau of labor and statistics data source, a center for disease control data source, and a world health organization data source. First, for each data source of the plurality of data sources, software running on the computer accesses the each data source, extracts data from the each data source, and inputs the data into a knowledge base having artificial intelligence. Second, the software gathers user data including a name of a user, an age of the user, a gender of the user, an ethnicity of the user, and a current financial profile related to the user of the system for financial prediction. Third, using the user data and the knowledge base, the software predicts future life events, the life events associated with financial impact to a financial profile of the user. Fourth, using the future life events and the financial impact, the software generates a report showing the life events and financial data over time.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a system for financial prediction.

FIG. 2 illustrates a schematic view of a computer as used by the system for financial prediction.

FIG. 3 illustrates a sample output of the system for financial prediction.

FIG. 4 illustrates a second sample output of the system for financial prediction.

FIGS. 5-14 illustrate exemplary data input user interfaces of the system for financial prediction.

FIG. 15 illustrates an operational model of the system for financial prediction.

FIG. 16 illustrates a list of sample life events and live stages in the system for financial prediction.

FIG. 17 illustrates a list of various information used for predictions in the system for financial prediction.

FIG. 18 illustrates a list of sample life stages as used for predictions in the system for financial prediction.

FIGS. 19-21 illustrate sample program flow charts for the system for financial prediction.

FIGS. 22A-22F illustrate sample data sources used by the system for financial prediction.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, the term, “Life Event,” refers to any event that has the potential to inflict financial changes. There are many life events, both having positive or negative financial impact. Examples of life events include, but are not limited to, bankruptcy, birth/adoption, buy/sell car, buy/sell home, change jobs, child care, college, death, disabled, disaster, divorce/separate, first job, foreclosure, foreign national, gamble/gift/prize, home equity loan, hosting people (e.g., parents), inheritance, injury, lawsuit, live together/marriage, major illness, military, moved residence, non-bus debt (bad), IRA/401k pre-distribution, 2nd car/home, receiving an IRS notice, receiving additional income, retirement, start a new business, stock options, etc.

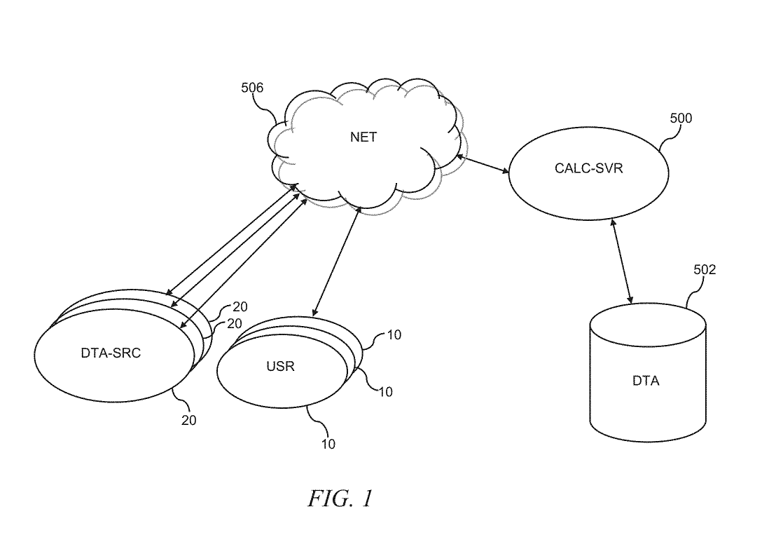

Referring to FIG. 1 illustrates a data connection diagram of the system for financial prediction. In this example, one or more user devices 10 communicate through the wide area network 506 (e.g. the Internet) to a server computer 500. That which is shown in FIG. 1 is but an exemplary connection layout and is in no way limiting as other networking configurations are anticipated as known in the art.

The server computer 500 has access to data storage 502. The server computer 500 transacts with the user devices 10 through the network 506 to present menus to/on the user devices 10, obtain inputs from the user devices 10, and provide data to the user devices 10. In some embodiments, login credentials (e.g., passwords, pins, secret codes) are stored local to the user devices 10; while in other embodiments, login credentials are stored in a data storage 502 (preferably in a secured area) requiring a connection to login.

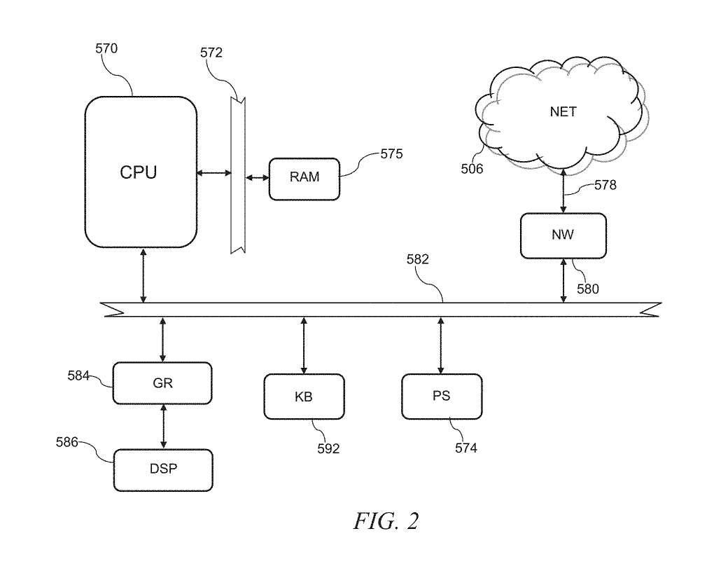

Referring to FIG. 2, a schematic view of a typical computer system (e.g., server 500 or user devices 10) is shown. The example computer system 500 represents a typical computer system used for back-end processing, calculating financial models, generating reports, displaying data, etc. This exemplary computer system is shown in its simplest form. Different architectures are known that accomplish similar results in a similar fashion and the present invention is not limited in any way to any particular computer system architecture or implementation. In this exemplary computer system, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus—USB). The graphics adapter 584 receives commands from the processor 570 and controls what is depicted on a display image on the display 586. The keyboard interface 592 provides navigation, data entry, and selection features.

In general, some portion of the persistent memory 574 is used to store programs, executable code, data, contacts, and other data, etc.

The peripherals are examples and other devices are known in the industry such as speakers, microphones, USB interfaces, Bluetooth transceivers, Wi-Fi transceivers, image sensors, temperature sensors, etc., the details of which are not shown for brevity and clarity reasons.

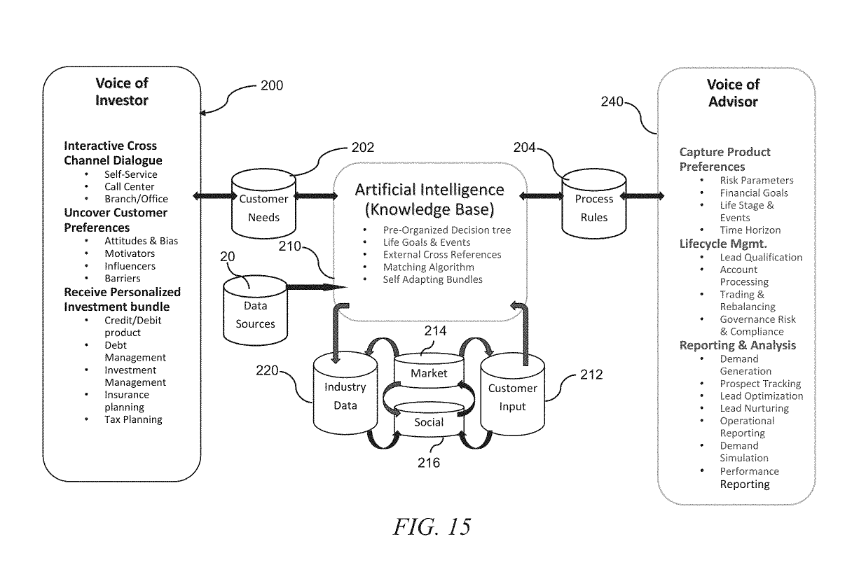

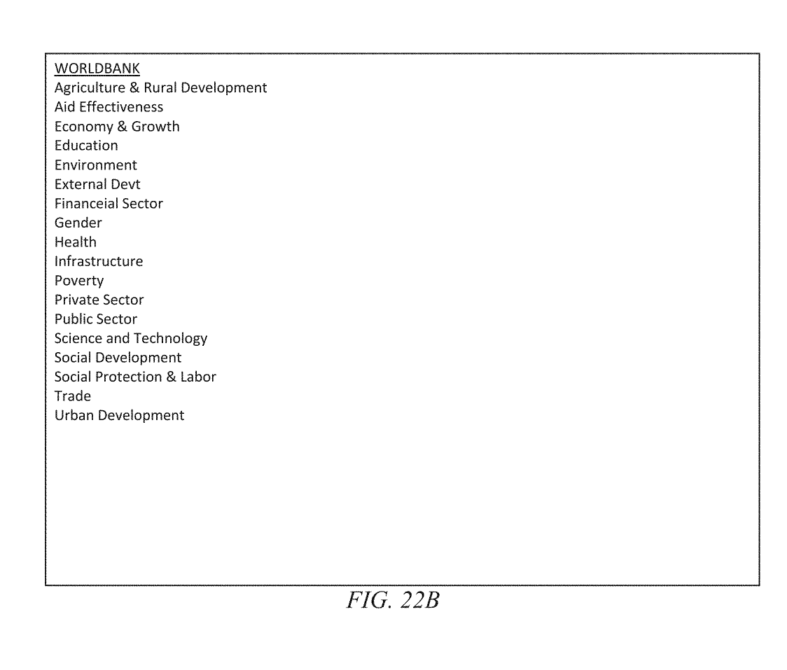

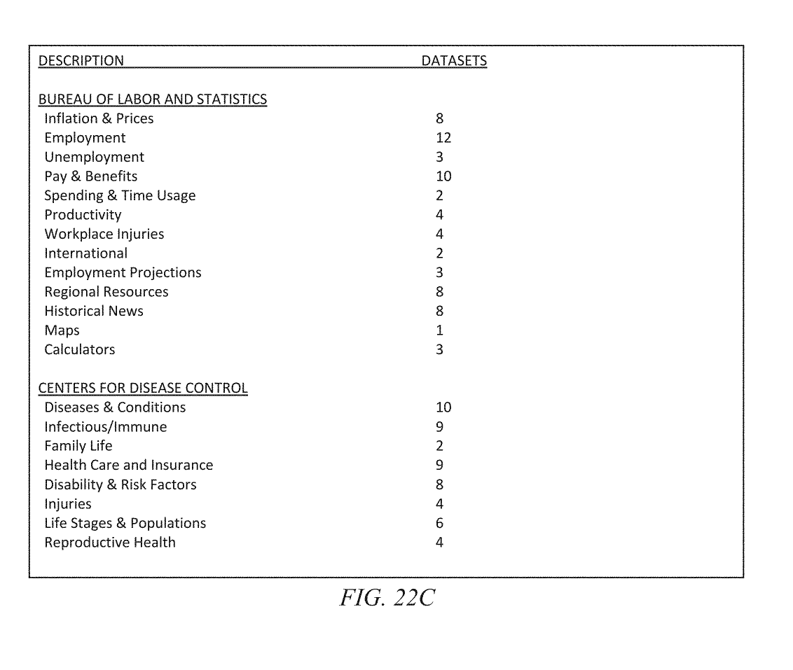

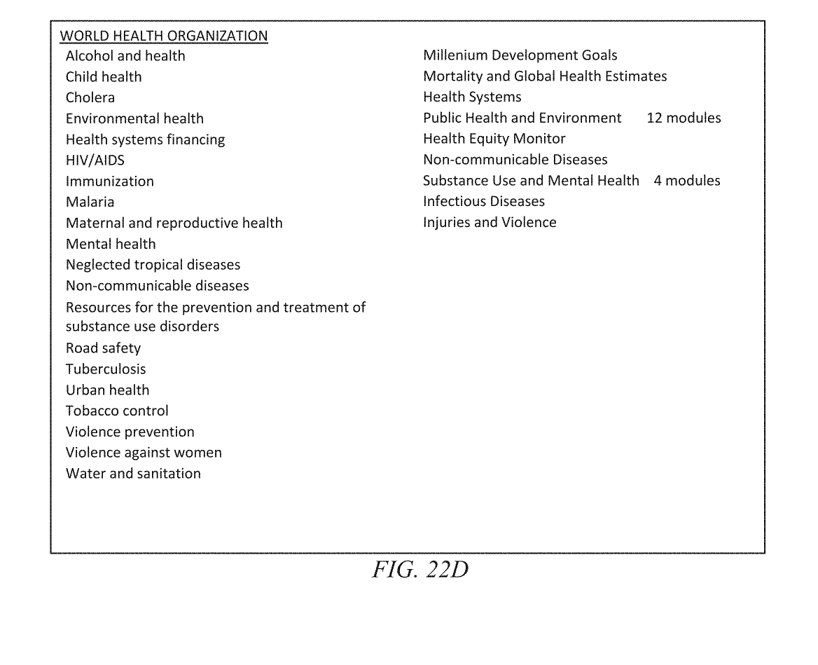

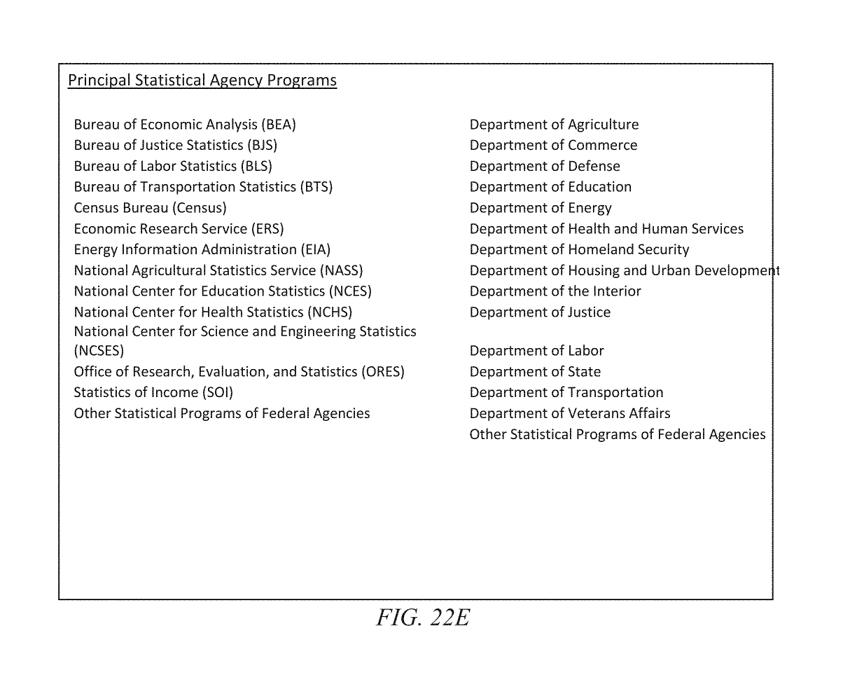

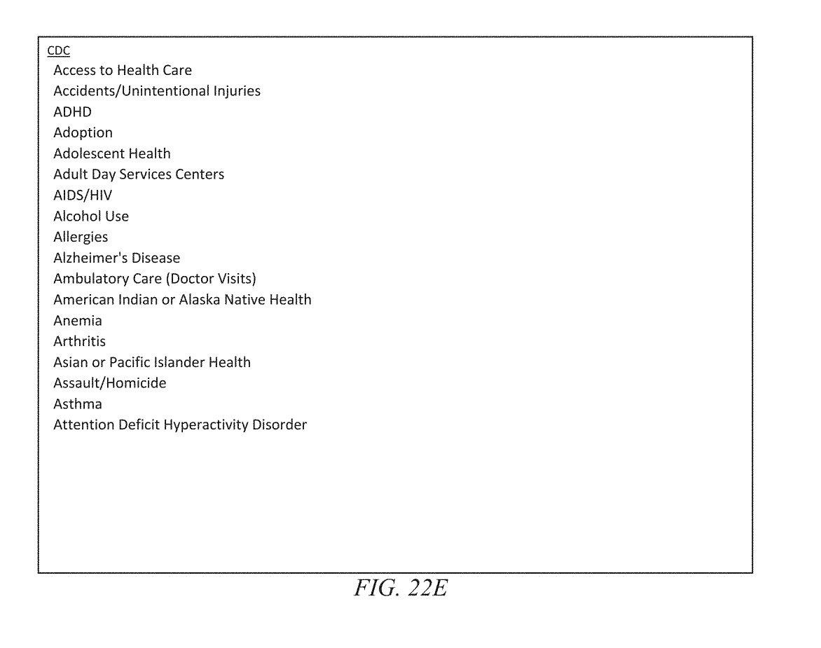

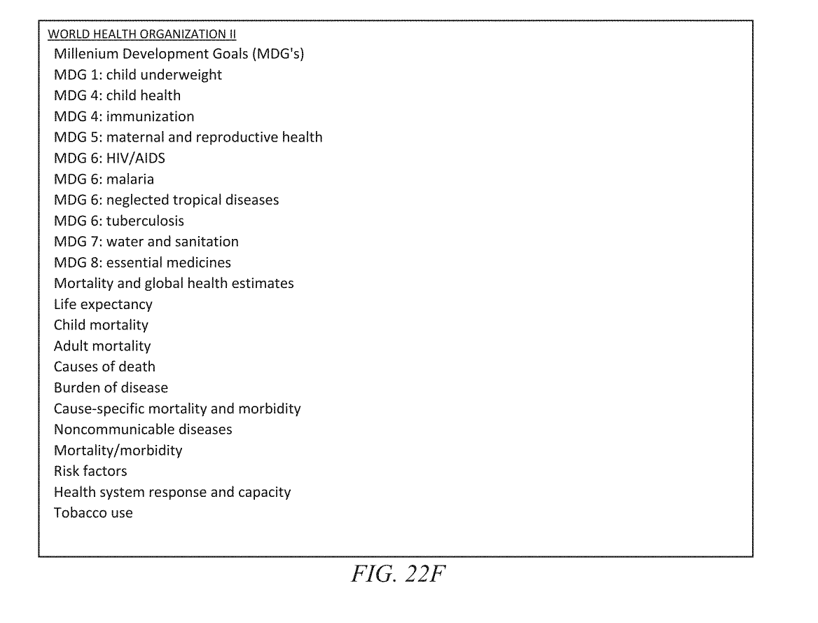

In FIG. 1, multiple data sources 20 as shown connected to the server 500 through the network 506. The type of connection is not important and can be through the network 506, through any form of data communication, including data transfer by bulk means such as magnetic tape, disk, drive, etc. The data sources 20 are used to feed a knowledge base 210 (see FIG. 15) stored in the data storage 502 that is connected to the server 500. The knowledge base 210, as will be shown, is used to predict life events once the user's information is entered, as will be shown. Any number of data sources 20 are anticipated from public agencies or from private companies. Any or all data sources are anticipated including any of the following, but not limited to the following: Data.gov, Worldbank, Fed Stats, BLS, World Health Organization, WHO II, Department of Justice, Federal Bureau of Investigation, Department of Health Services, various other US Departments (i.e. Agriculture, Commerce, Education, Energy, Health & Human Services, Interior, Justice, State, Transportation), various National Centers and Institutes such as BTES, National Center for Education Statistics (NCES), National Center for Health Statistics (NCHS), Federal Emergency Management Administration (FEMA), National Cancer Institute (NCI), NCMSD, National Institute on Drug Abuse (NIDA). In addition, some data sources include private sources such as Realtor.org, Zillow.com, etc. A partial list of data sources 20 is included in FIGS. 22A-22F. Again, any or all of the data sources 20 that are suggested, as well as other data sources is anticipated to develop the knowledge base 210 of the system for financial prediction.

Throughout this document, the term “user” refers to the person or persons for which the financial prediction is to be made.

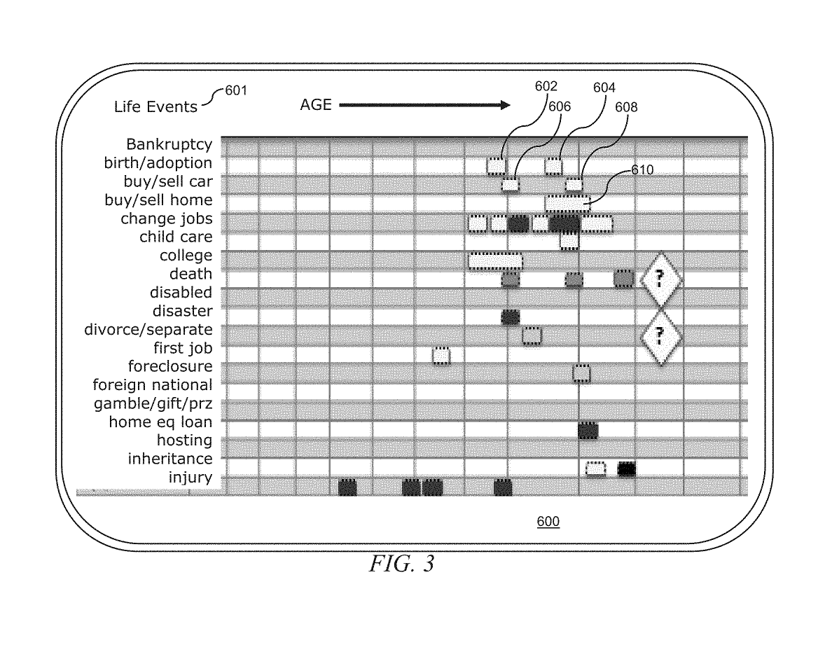

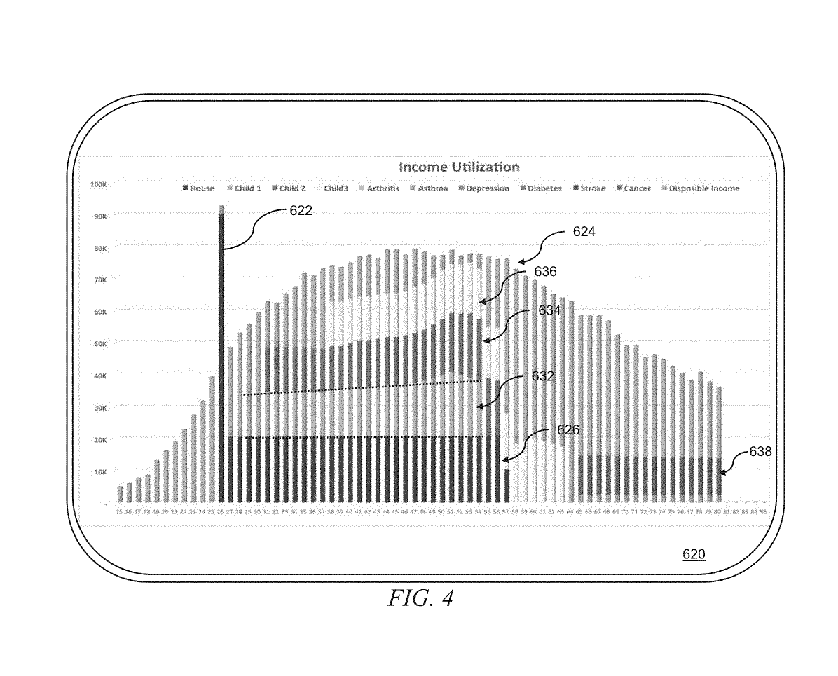

Referring to FIG. 3, a sample output of the system for financial prediction is shown. As is shown in FIG. 3, there are several life events 601, though not necessarily the complete list of life events (for example, a robbery or a lawsuit). Prior financial modeling systems take into account the age of the user, the life expectancy of the user, but little else. For example, not one prior art financial modeling system attempts to predict that the user will divorce, when the user will likely divorce, and what the financial impacts of the divorce will be. No prior modeling system utilizes a location of the user to better predict costs such as housing and college, medical costs, etc.

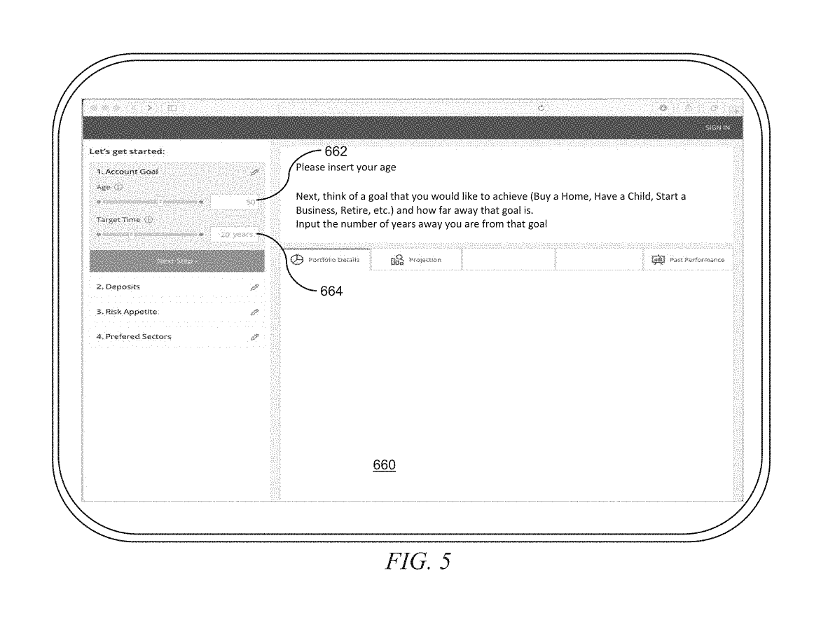

The system for financial prediction utilizes data provided by the user (see FIGS. 5-13 for examples of such) to make such predictions based upon knowledge extracted from the multitude of data sources 20 such as any or all of: Data.gov, Worldbank, Fed Stats, BLS, World Health Organization, WHO II, Department of Justice, Federal Bureau of Investigation, Department of Health Services, various other US Departments (i.e. Agriculture, Commerce, Education, Energy, Health & Human Services, Interior, Justice, State, Transportation), various National Centers and Institutes such as BTES, National Center for Education Statistics (NCES), National Center for Health Statistics (NCHS), Federal Emergency Management Administration (FEMA), National Cancer Institute (NCI), NCMSD, National Institute on Drug Abuse (NIDA), Realtor.org, Zillow.com, etc. By combining data from the data sources 20 into a knowledge base 210, questions can be asked of the knowledge base 210 regarding the user. Given the age, educational background, sex, race, and location of the user, the knowledge base 210 will provide predictions of when the user will marry, have children, buy a home, enter/exit college, divorce, etc. Further, additionally having detailed medical history and family medical history, the knowledge base 210 will provide predictions of medical issues (e.g. heart attack, cancer, renal problems, etc.) and, having user data indicating location, the cost of such issues are predicted. Further, although actuarial tables are often used to predict life expectancy, such tables take into account only sex and smoking (yes or no). Having the knowledge base 210 that incorporates data from, for example, the World Health Organization, WHO II, the National Center for Health Statistics (NCHS), and the National Cancer Institute, given the user health data and family history, a much more realistic life expectancy of the user is predicted.

As an example, the chart 600 shown in FIG. 3 shows an abbreviated list of 19 life events 601 listed at the left (Bankruptcy . . . injury) but there are many other life events that are considered such as a lawsuit, living together/marriage, major illness, military, moved, residence, non-business debt (Bad), IRA/401k pre-retirement distribution, 2^{nd} car, 2^{nd} home, receipt of an IRS notice, receipt of additional income, retirement, start of a new business, stock options, etc. In the chart 600, the X-axis is age (typically shown in years starting at the current age of the user).

In the chart 600, many life events that have been predicted by using the knowledge base 210 are shown as rectangles under the age of the user when they are predicted to occur. For example, there are predictions for two children 602/604 (birth or adoption) on the line labeled “birth/adoption.” There are predictions for purchases of two cars 606/608 (birth or adoption) on the line labeled “birth/adoption.” It should be noted that the prediction machine made predictions of purchases of two cars 606/608 shortly after the predictions of each of the children 602/604 as new vehicles are often needed to accommodate larger families. Another notable prediction is a home purchase and/or sale 610. It is hard to believe that financial models of the past can predict any level of financial achievement (e.g. cash available at retirement) without taking into account these major financially impacting events.

Referring now to FIG. 4, a second sample output of the system for financial prediction is shown. In FIG. 4, an income utilization chart 620 is presented for the user. The Y-axis is in money increments (e.g. dollars for the USA from $10K up to $100K). Each vertical bar represents one year and each vertical bar contains color-coded sub-bars indicating yearly costs associated with the life events.

In this exemplary income utilization chart 620, the first years (e.g. age 15 to 25) show only disposable income 624, each year increasing as the user receives pay increases and gains investments from savings, etc. Then, a first life event is predicted at age 26—a home purchase. This is represented by a tall vertical bar 622 that includes a dark sub-bar representing house payments 626 during the year the user is 26 years old (e.g. the down payment for a house and monthly payment in that year totaling $90,000) and a lighter sub-bar at the top for medical costs for depression. Note, in that year there is no disposable income.

In subsequent years (age 27-28) vertical bars include the house payments 626 and disposable income 624. Then, in year 29, another life event occurs—a first child is born. The costs associated with the first child 632 reduces the disposable income 624 (top of each bar). In year 31, another life event occurs—a second child is born. The costs associated with the second child 634 further reduces the disposable income 624 (top of each bar). In year 38, another life event occurs—a third child is born. The costs associated with the third child 636 further reduces the disposable income 624 (top of each bar). Note that the predicted financial impact of the first child ends at age 54, the second child at age 56, and the third child at age 63. Then, at age 65, another life event occurs, a cancer diagnosis. The cost of cancer treatment is shown for ages 65-80 at which the user's life is predicted to end.

All of this prediction is based upon the knowledge extracted from data sources 20 and the detail data provided by the user (see below). Take for example the income utilization chart 620. Assume the chart 600 is for an Asian female of age 21 living in Dallas, Tex. and working in the Biology Medical field and a certain set of data regarding health, etc. Now assume that the same person, with the same age, field, and data is living in rural Minnesota. In such, the income predictions will be lower based upon the average income for one in the Biology Medical field in Minnesota vs. Dallas Tex. The costs for raising each child are reduces as many family-related costs are lower in rural Minnesota vs. Dallas Tex. The costs for cancer treatment increase as travel and lodging are necessary to seek specialized care. This is but a sample of many differences in life events, disposable income, life expectancy, based upon changing only one input datum—location. Further differences may also include number of children, other costs, commuting costs, etc., based upon only a change of location. Such predictions are not only useful in predicting financial status, but are also useful in comparing where you will live/move and your occupation. Being that you cannot change your genetic makeup, keeping such static and changing location or occupation, the user will see different income utilization charts 620 reflective of each change, leading to making informed decisions regarding location and/or occupation.

Referring to FIGS. 5-14, exemplary data input user interfaces of the system for financial prediction are shown. The detail data is typically provided by the user, perhaps during one or meetings with a financial advisor or by direct entry into an application user interface. The detail data provided by the user in FIGS. 5-15 is meant to be an example as in some embodiments, more or less detail data is provided by the user. For example, to better predict certain medical life events, including life expectancy, genealogical data is another data input that, in some embodiments, is provided by the user, for example, as provided by a DNA screening.

In FIG. 5, a first user interface 660 is used to enter the user's present age 662 and target time period 664 that the user wants to attain a certain goal (e.g. retirement, start a business, buy a home, have children).

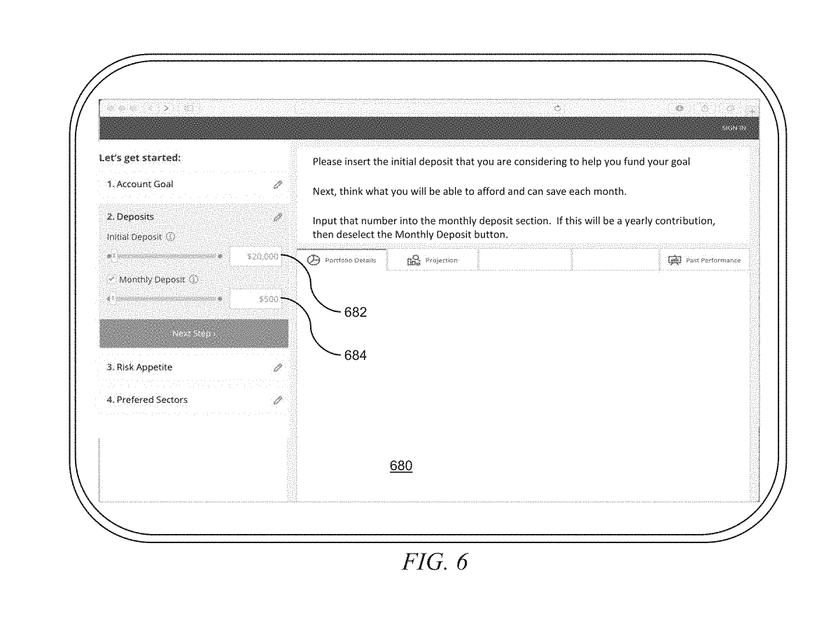

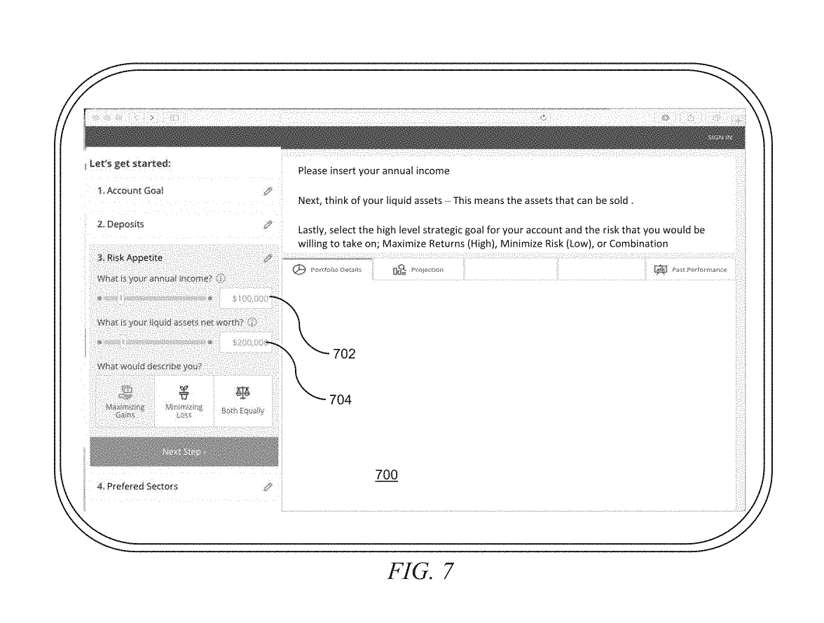

In FIG. 6, a second user interface 680 is used to enter the user's initial funding 682 and monthly additions/deposits 684.

In FIG. 7, a third user interface 700 is used to enter the user's annual income 702 and liquid net worth 704.

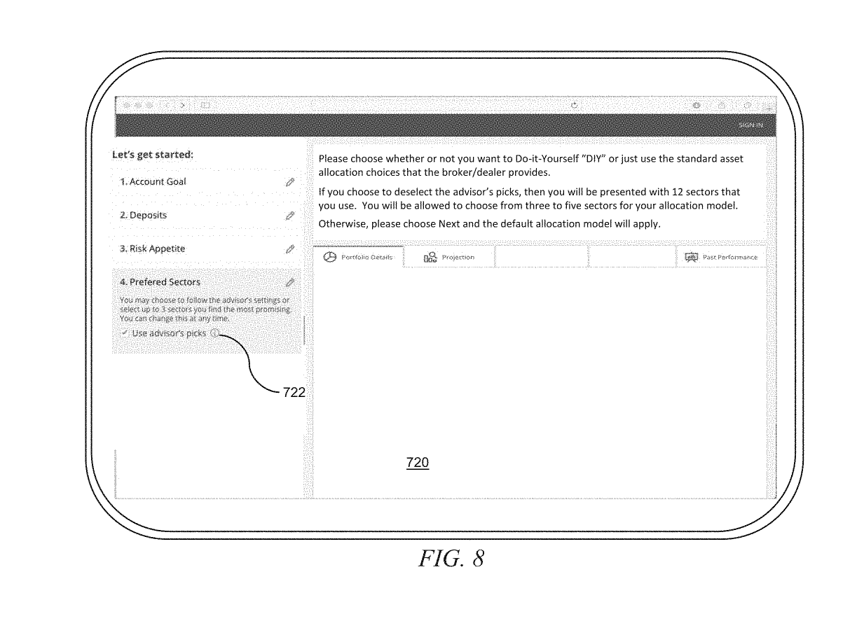

In FIG. 8, a fourth user interface 720 is used to enter the user's investment sectors. In this example, for brevity and clarity reasons, the user has opted to follow the advisor's picks 722.

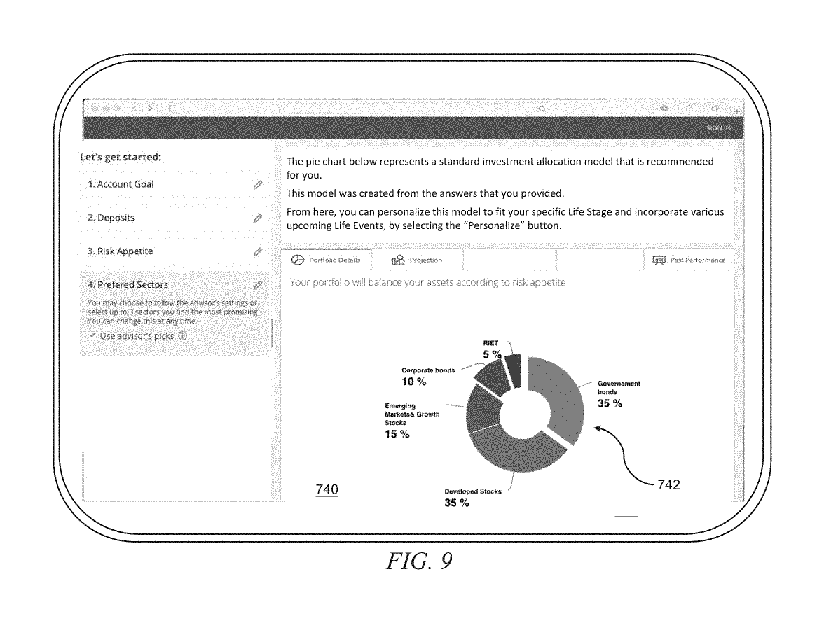

In FIG. 9, a fifth user interface 740 shows an allocation pie chart 742 of asset allocations per the advisor's picks 722.

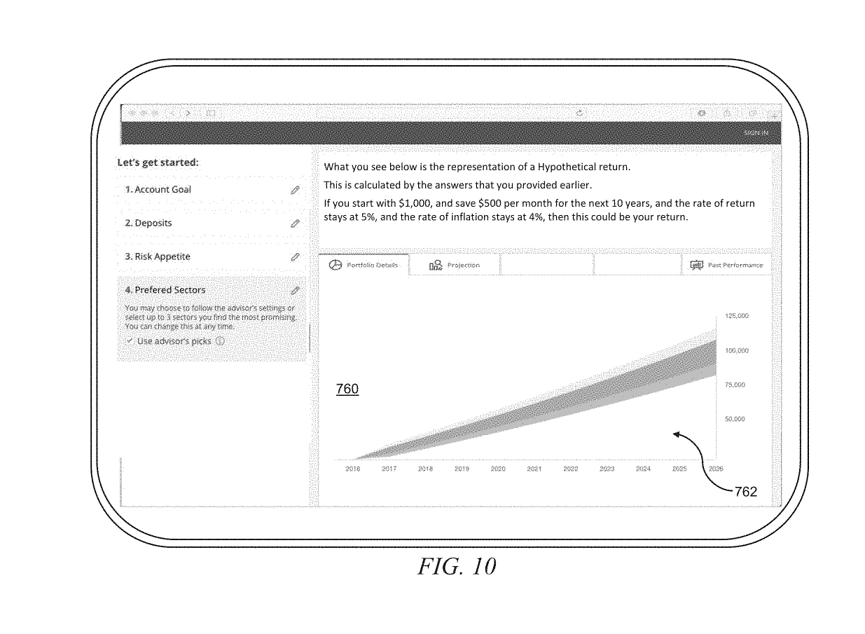

In FIG. 10, a sixth user interface 760 shows an asset growth chart 762 showing a range of returns on the initial funding 682 and monthly deposits 684.

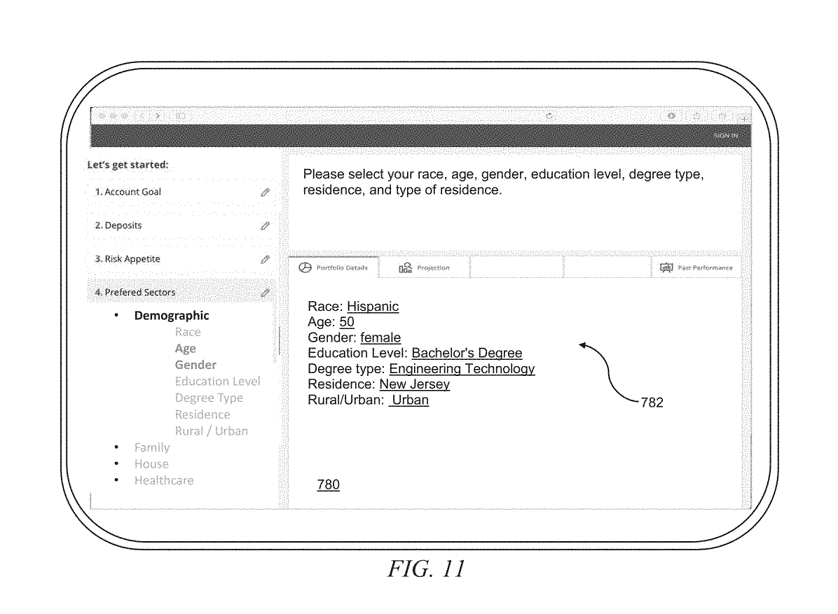

In FIG. 11, a seventh user interface 780 is used to enter the user's demographic information. In this example, the user enters demographic data 782 for race, age, gender, education level, degree type, residence, and whether they live in a rural or urban area.

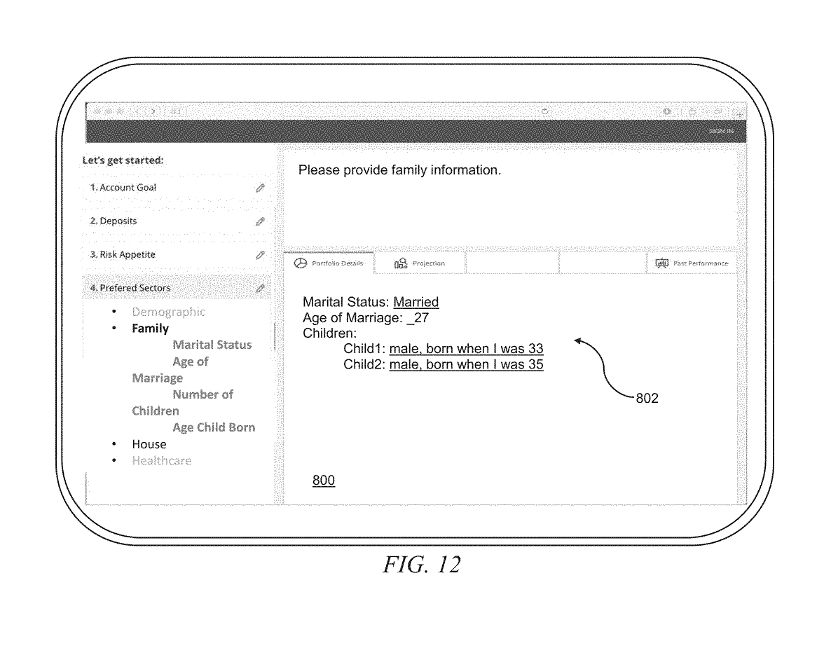

In FIG. 12, an eighth user interface 800 is used to enter the user's family information. In this example, the user enters family data 802 for marital status (single, married, divorced, living together, etc.), age when married, number of children and age when each child was born.

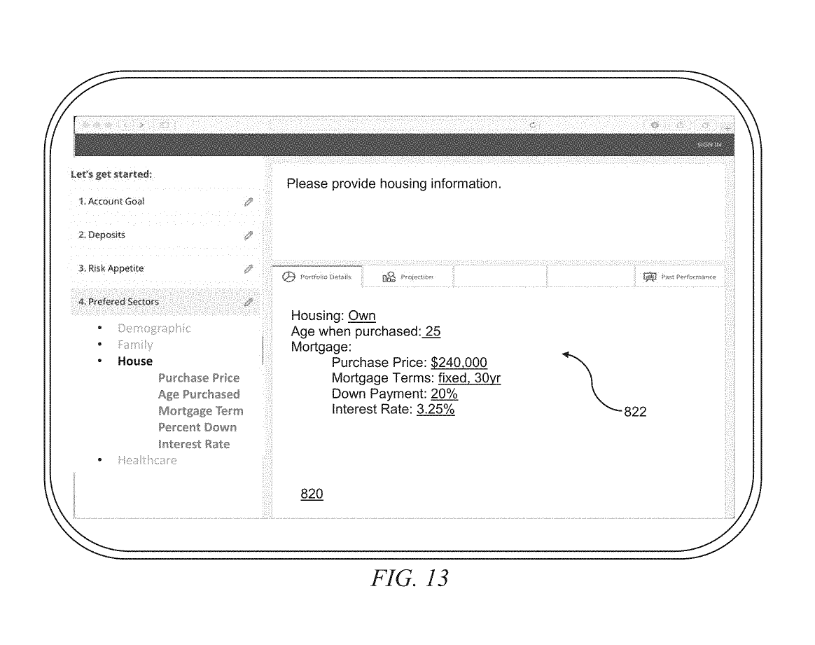

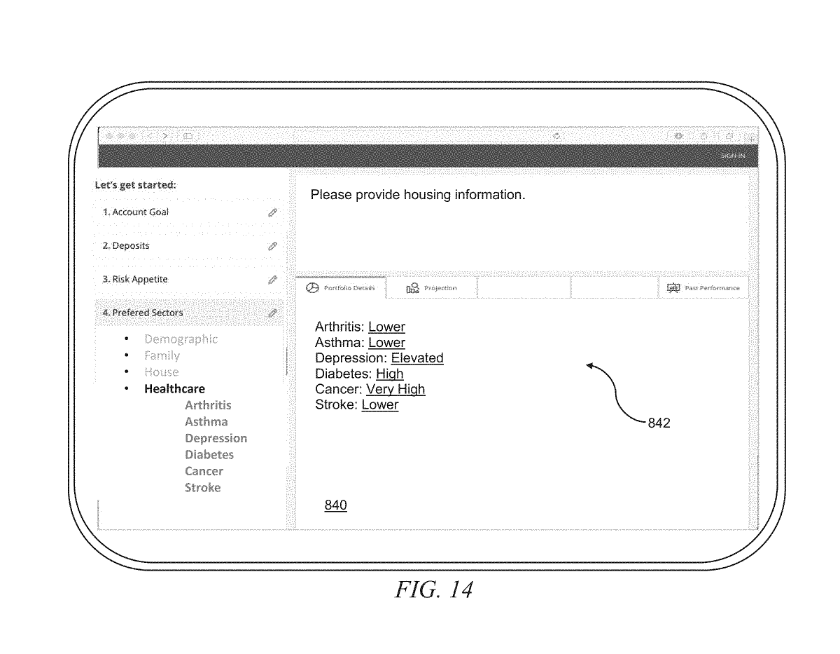

In FIG. 13, a ninth user interface 820 is used to enter the user's housing information. In this example, the user enters housing data 822 for housing type (e.g. own, lease, rent), age when the user purchase the home, purchase price of the home, mortgage terms, down payment, and interest rate.

In FIG. 14, a tenth user interface 840 is used to enter the user's healthcare information. In this example, the user enters healthcare data 842 for arthritis, asthma, depression, diabetes, cancer, and stroke. This is just an example of health-related data that the user provides, as many more health-related data are anticipated, all or some of which are included in various embodiments of the present invention. For example, certain other diseases (e.g. HIV, Hepatitis), family/genetic issues (e.g. a parent with high blood pressure or high cholesterol), current diet (e.g. fast food and soda, vegetarian, Mediterranean, moderately healthy), exercise (e.g. daily exercise, twice a week, couch potato), etc.

Referring to FIG. 15, an operational model of the system for financial prediction is shown. In operation, the system for financial prediction receives data 200 from the user (investor), often by way of a financial advisor. The inputs/data 200 are saved as the customer needs.

Independent of such, a model is continually refined using a semantic engine, retrieving and analyzing the data sources 20, developing the knowledge base 210 that is used to predict life events.

Industry data 220, market data 214 (e.g. stock market, bond market), social data 216 (e.g. political events, social trends), and customer inputs 212 also feed the knowledge base 210.

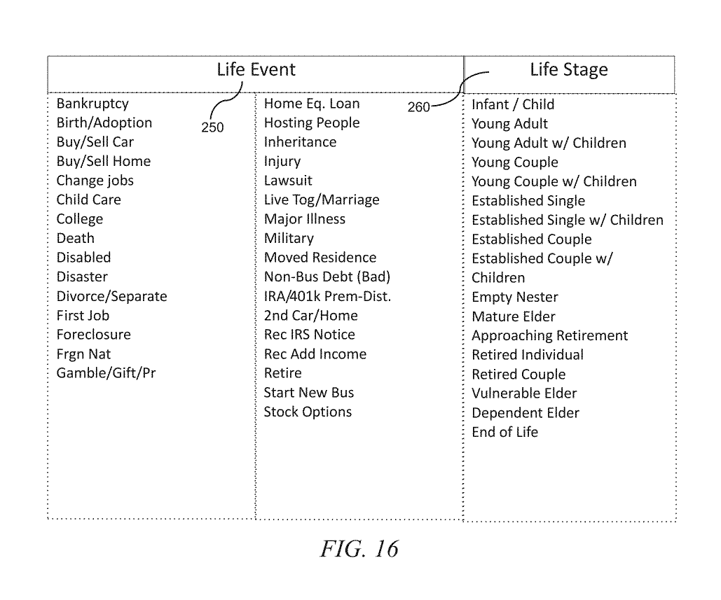

Feeding the customer needs 202 (e.g. data provided by the user as in FIGS. 5-13) into the artificial intelligence engine (knowledge base 210), using a set of process rules, output data/reports 240 are generated, for example, reports as in FIGS. 3 and 4. These reports include predicted life events (e.g. life events 250—see FIG. 16), life stages (e.g. life stages 260—see FIG. 16), risk parameters, etc. These reports become the voice of a financial advisor in consulting the user.

Referring to FIG. 16, exemplary sets of life events 250 and life stages 260 are shown. Although 32 life events 250 are shown, any number of life events are anticipated and, in some embodiments, the life events 250 are named differently. For example, one life event 250 is “Change jobs.” It is anticipated that this life event 250, in some embodiments, will have different names such as “resigned,” “laid-off,” “fired,” and “new job.” Likewise, in some embodiments, “Injury” is divided into short-term disability and long-term disability. There are no limitations as to the number, names, and types of life events 250.

The same is true with the life stages 260.

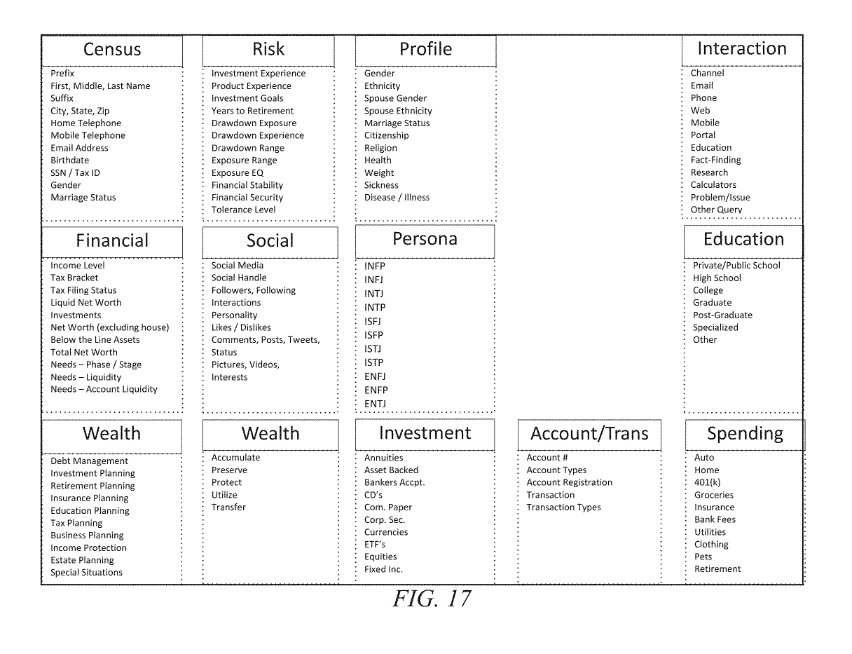

Referring to FIG. 17, a list of various information used for predictions in the system for financial prediction is shown. For example, to provide sensible financial data and predictions, it is important to know the user's net worth, income, tax bracket, state in which earnings are made, goals, risk adversity, spending trends (e.g. vehicles, groceries, dining, utilities, mortgage/rent), etc. Further, to provide guidance to the user, the system needs to know what types of investments are available and their expected returns. For example, fixed income, bonds, stocks, mutual funds, etc. Other data is used to help predict life events, for example education levels, ethnicity, marital status, religion, weight/height, health, etc. For example, a person with a Master's Degree may be predicted to live longer than a person of similar health, etc., without any degree.

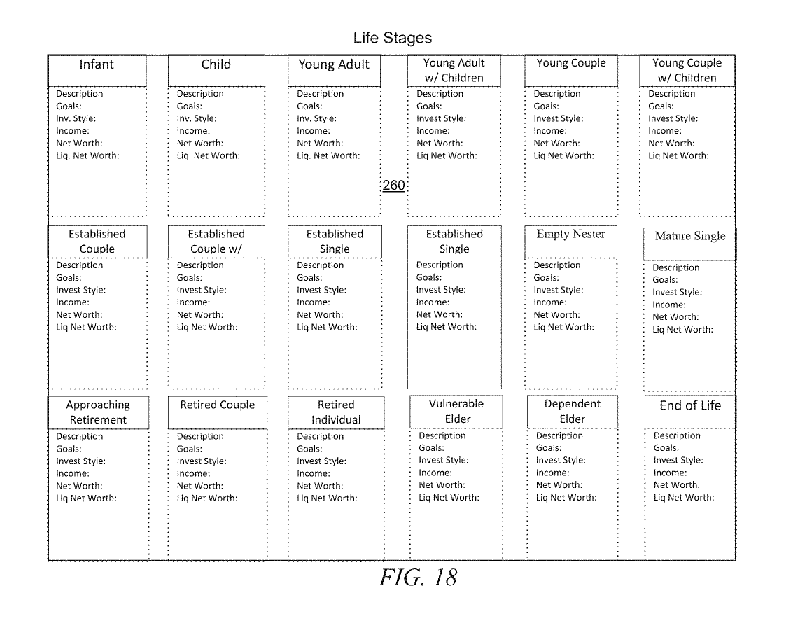

Referring to FIG. 18, a list of sample life stages 260 as used for predictions in the system for financial prediction is shown. Different life stages 260 dictate or predict different life events 250. For example, one who is in the life stage 260 of infant or child will likely not have a life event 250 of, for example, having a child for a much longer period of time than one who is in the life stage 260 of young couple. Likewise, one who is in the life stage 260 of Vulnerable Elder will likely not have a life event 250 of having a child. Therefore, the life stages 260 are used with the knowledge base 210 to better predict future life events 250.

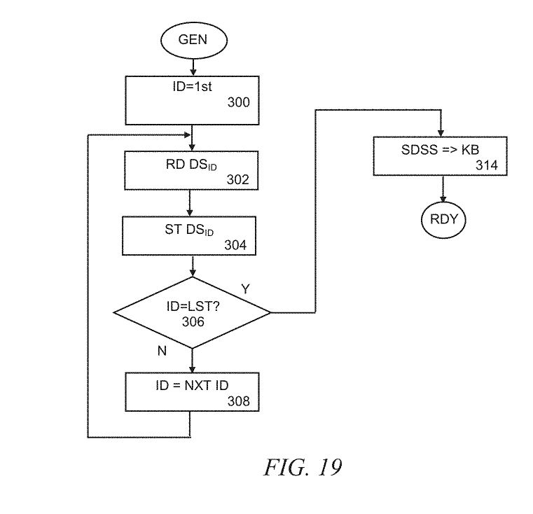

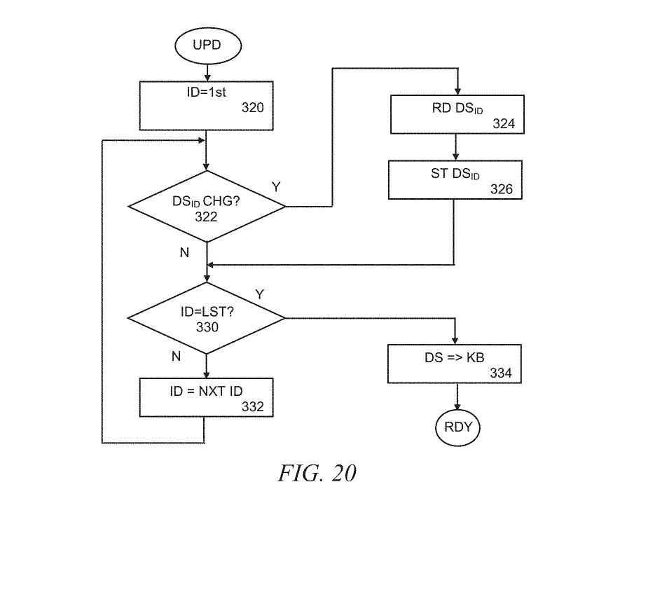

Referring to FIGS. 19-21, sample program flow charts for the system for financial prediction are shown. The high-level flow charts of FIGS. 19-21 are for illustration purposes and are described in brief form to convey the overall operation of the system for financial prediction. One skilled in the art of programing and artificial intelligence, without undue experimentation and using this description, would have little difficulty developing the described system for financial prediction.

In FIG. 19, the knowledge base 210 is generated. To start, an identifier is set 300 to a first data source 20. That data source 20 is read 302 and the significant data from that data source 20 is stored 304. Next, a test 306 is performed to determine if the identifier is set to the last data source 20. If the identifier is not set to the last data source 20, then the above steps are repeated.

If the identifier is set to the last data source 20, then the stored data sources are imported 314 into the knowledge base 210 as known in the field of artificial intelligence. For example, nodes and weights are created in an artificial intelligence program or hardware for each datum in the stored data sources.

In FIG. 20, the knowledge base 210 is updated when a data source 20 is updated or changed. To start, an identifier is set 320 to a first data source 20. Next, a test 322 is performed to determine if that data source 20 has changed. If the test 322 determines that the data source 20 has changed, that data source 20 is read 324 and the significant data from that data source 20 is stored 326. Next, a test 330 is performed to determine if the identifier is set to the last data source 20. If the identifier is not set to the last data source 20, then the above steps are repeated.

If the identifier is set to the last data source 20, then the stored data sources are imported 334 into the knowledge base 210 as known in the field of artificial intelligence. For example, nodes and weights are created in an artificial intelligence program or hardware for each datum in the stored data sources.

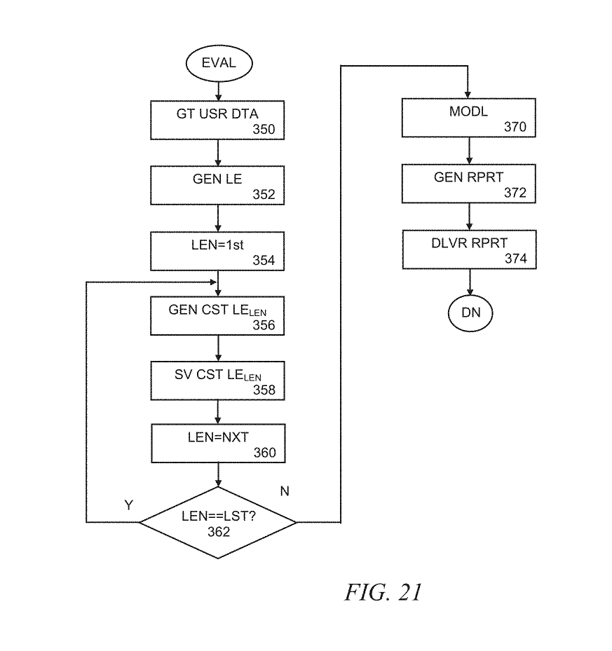

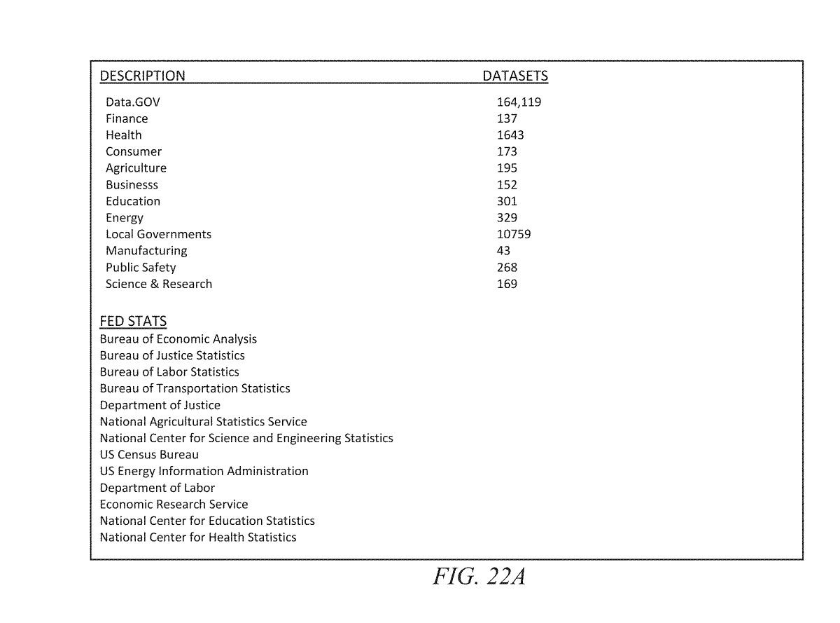

In FIG. 21, after the knowledge base 210 is generated and/or updated, the knowledge base 210 is available to generate reports using the user data. To start, the user data is retrieved 350 (e.g. as shown in FIGS. 5-13). Next, using the user data and the knowledge base 210, a set of life events 250 are generated 352. An identifier is set 354 to the first life event 250 and a cost associated with the current life event is generated 356. For example, if the current life event is having a baby, then, using the knowledge base 210, a yearly cost for supporting the baby is generated for the number of years that the baby will be under the care of the user (e.g. until age 18 or age 21). The cost associated with the current life event is saved 358 and the identifier is set 360 to the next life event. A test 362 is performed to determine if current life event 250 is the last live event 250 that was generated (step 352). If the test 362 determines that the current life event 250 is not the last live event 250, the above steps 356-362 are repeated.

If the test 362 determines that the current life event 250 is the last live event 250, a financial model is generated 370 for the user using the life events, the costs associated with the life events, financial prediction data from the stored data sources (e.g. expected asset growth dependent upon asset type, expected income growth, inflation, taxes, expected tax changes, etc.). The financial model is used to generate reports 372 that are then delivered 374 to the user and/or financial advisor.

Again, the above program flow is a simplified program overview of one possible implementation and is shown for understanding and is not limiting of the present application in any way.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for financial prediction, the system comprising:
a computer;
a plurality of data sources that are accessible by the computer;
for each data source, software running on the computer accesses the each data source, extracts data from the each data source, and inputs the data into a knowledge base having artificial intelligence;
the software gathers user data comprising a name of a user, an age of the user, a gender of the user, an ethnicity of the user, and a current financial profile related to the user of the system for financial prediction;
using the user data and the knowledge base, the software predicts future life events, the life events associated with a financial impact to a financial profile of the user; and
using the future life events and the financial impact, generating a report showing the life events and financial data over time.

2. The system of claim 1, wherein the user data further comprises an educational level of the user, a degree type/field of the user, a residency of the user, and an indication of rural or urban living of the user.

3. The system of claim 2, wherein the user data further comprises a marital status of the user, a list of children of the user along with ages for each child in the list of children, and a marriage age when the user was married.

4. The system of claim 3, wherein the user data further comprises a type of dwelling of the user; and if a dwelling of the user was purchased, an age of the user when the dwelling was purchased, a purchase price of the dwelling, a mortgage term, an interest rate, and a down payment amount related to a loan for the dwelling.

5. The system of claim 4, wherein the user data further comprises health-related information related to the user.

6. The system of claim 5, wherein the user data further comprises financial goals of the user.

7. A method of making financial predictions, the method comprising:
identifying a plurality of data sources;
for each data source of the plurality of data sources, accessing the each data source, extracting data from the each data source, and importing the data into a knowledge base, the knowledge base having artificial intelligence;
next, gathering user data from a user, the user data comprising a name of the user, an age of the user, a gender of the user, an ethnicity of the user, and a current financial profile related to the user;
next, using the user data and the knowledge base to predict future life events, the life events associated with a financial impact to a financial profile of the user; and
using the future life events and the financial impact, generating a report showing the life events and financial data over time.

8. The method of claim 7, further comprising the steps of monitoring each data source of the plurality of data sources for updates/changes and upon detecting the updates/changes in one of the data sources of the plurality of data sources, accessing the one of the data source, extracting data from the one of the data source, and importing the data into the knowledge base

9. The method of claim 7, wherein the user data further comprises an educational level of the user, a degree type/field of the user, a residency of the user, and an indication of rural or urban living of the user.

10. The method of claim 9, wherein the user data further comprises a marital status of the user, a list of children of the user along with ages for each child in the list of children, and a marriage age when the user was married.

11. The method of claim 10, wherein the user data further comprises a type of dwelling of the user; and if a dwelling of the user was purchased, an age of the user when the dwelling was purchased, a purchase price of the dwelling, a mortgage term, an interest rate, and a down payment amount related to a loan for the dwelling.

12. The method of claim 11, wherein the user data further comprises health-related information related to the user.

13. The method of claim 12, wherein the user data further comprises financial goals of the user.

14. A system for financial prediction, the system comprising:
a computer;
a plurality of data sources that are accessible by the computer, the plurality of data sources comprising a bureau of labor and statistics data source, a centers for disease control data source, and a world health organization data source;
first, for each data source of the plurality of data sources, software running on the computer accesses the each data source, extracts data from the each data source, and inputs the data into a knowledge base having artificial intelligence;
second, the software running on the computer gathers user data comprising a name of a user, an age of the user, a gender of the user, an ethnicity of the user, and a current financial profile related to the user of the system for financial prediction;
third, using the user data and the knowledge base, the software running on the computer predicts future life events, the life events associated with a financial impact to a financial profile of the user; and
fourth, using the future life events and the financial impact, the software running on the computer generating a report showing the life events and financial data over time.

15. The system of claim 14, wherein the user data further comprises an educational level of the user, a degree type/field of the user, a residency of the user, and an indication of rural or urban living of the user.

16. The system of claim 15, wherein the user data further comprises a marital status of the user, a list of children of the user along with ages for each child in the list of children, and a marriage age when the user was married.

17. The system of claim 16, wherein the user data further comprises a type of dwelling of the user; and if a dwelling of the user was purchased, an age of the user when the dwelling was purchased, a purchase price of the dwelling, a mortgage term, an interest rate, and a down payment amount related to a loan for the dwelling.

18. The system of claim 17, wherein the user data further comprises health-related information related to the user.

19. The system of claim 18, wherein the user data further comprises financial goals of the user.

20. The system of claim 14, wherein the plurality of data sources further comprises a bureau of labor and statistics data source and a world bank data source.
